(19) United States
(12) Patent Application Publication
(10) Pub. No.: US 2009/0205277 A1
(43) Pub. Date: Aug. 20, 2009

(54) Construction Panel System And Method Of Manufacture Thereof

(76) Inventor: A. David Gibson, Mesa, AZ (US)

Correspondence Address: BRYAN CAVE LLP, TWO NORTH CENTRAL AVENUE, SUITE 2200, PHOENIX, AZ, 85004, US

(21) Appl. No.: 12/114,702

(22) Filed: May 2, 2008

Related U.S. Application Data
(60) Provisional application No. 61/029,882, filed on Feb. 19, 2008.

(51) Int. Cl. E04C 2/34; E04C 2/24; E04C 2/38; B32B 37/00

(52) U.S. Cl. 52/309.9; 52/794.1; 52/656.1; 156/60

(57) ABSTRACT

In one embodiment, a construction panel system comprises a first panel of one or more construction panels. The first construction panel comprises a core board, a first insulation layer coupled to a first side of the core board, and a second insulation layer coupled to a second side of the core board, where the core board provides a structural integrity for the first panel, the first insulation layer substantially covers the first side of the core board and the second insulation layer substantially covers the second side of the core board.

### CROSS-REFERENCE TO RELATED APPLICATION

This application claims the benefit of U.S. Provisional Patent Application No. 61/029,882, filed Feb. 19, 2008.

### TECHNICAL FIELD

This disclosure relates generally to construction systems, and relates more particularly to construction panel systems and methods for manufacturing and/or assembling construction panel systems.

### BACKGROUND

Today's construction industry relies upon building technology dating back several hundreds of years. Stick framing is the current chosen method of construction for both custom and production home builders, and for light commercial construction. Stick framing, however, has been riddled with problems including skilled labor shortages, reduced energy efficiency due to low insulation values (R-values), and price fluctuations and environmental impact due to dependence on wood. Newer construction systems have been proposed, including SIPS (structural insulated panel system) and CIFS (concrete insulated form system) to address some of these concerns. None of these newer systems, however, comprise a pre-assembled construction panel system capable of effectively competing in terms of cost, assembly time, and skilled labor requirements with present widespread construction methods.

Accordingly, a need exists for a construction panel system that addresses these problems by providing a competitive and practical option to current construction methods in terms of cost, skilled labor requirements, construction time, ease of assembly, energy efficiency, strength, and/or durability.

### BRIEF DESCRIPTION OF THE DRAWINGS

The invention will be better understood from a reading of the following detailed description of examples of embodiments, taken in conjunction with the accompanying figures in the drawings in which:

FIG. 1 illustrates a top, side, front and partially exploded isometric view of a construction panel system comprising a construction panel and a plate according to the first embodiment.

FIG. 2 illustrates a cross-sectional view of a plate coupled to the construction panel of FIG. 1.

FIG. 3 illustrates a cross-sectional view of another plate coupled to another construction panel, according to a second embodiment.

FIG. 4 illustrates a top view of the construction panel system of FIG. 1, showing the construction panel of FIG. 1 aligned to be coupled to another construction panel.

FIG. 5 illustrates a top view of the construction panel system of FIG. 1, showing a construction panel aligned to be coupled to another construction panel at a load-bearing junction.

FIG. 6 illustrates a side cross-sectional view of the construction panel system of FIG. 1 comprising a roof structure coupled to the construction panel of FIG. 1.

FIG. 7 illustrates an isometric view of a roof sheathing capable of being used with a roof structure.

FIG. 8 illustrates a view of the roof sheathing of FIG. 7 aligned for coupling with the roof structure.

FIG. 9 illustrates a top view of a plumbing panel coupled to other construction panels of the construction panel system of FIG. 1.

FIG. 10 illustrates an exploded view of different elements aligned to assemble a wall-opening structure of the construction panel system of FIG. 1.

FIG. 11 illustrates the wall-opening structure of FIG. 10, as assembled.

FIG. 12 illustrates a top cross-sectional view of a portion of the wall-opening structure of FIG. 10 coupled with a window.

FIG. 13 illustrates a top cross-sectional view of a portion of the wall-opening structure of FIG. 10 coupled with a window, where the wall-opening structure comprises a stucco exterior.

FIG. 14 illustrates a partially exploded isometric view of a panel-form configured to manufacture and/or assemble a construction panel of the construction panel system of FIG. 1.

FIG. 15 illustrates a top cross-sectional view of the panel-form of FIG. 14, as assembled.

FIG. 16 illustrates a top cross-sectional view of another panel-form similar to the panel-form of FIGS. 14-15.

FIG. 17 illustrates a cross-section of a plate-mold that can form part of a panel-form such as the panel-forms of FIGS. 14-16.

FIG. 18 illustrates a cross-section of a different plate-mold that can form part of a panel-form such as the panel-forms of FIGS. 14-16.

FIG. 19 shows a portion of the construction panel system of FIG. 1 configured to form an outside corner.

FIG. 20 shows a portion of the construction panel system of FIG. 1 configured to form an inside corner.

FIG. 21 shows a flowchart for a method for manufacturing and/or assembling a construction panel system such as described through FIGS. 1-20.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of examples of embodiments. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Furthermore, the terms “include,” and “have,” and any variations thereof, are intended to cover a non-exclusive inclusion, such that a process, method, article, or apparatus that comprises a list of elements is not necessarily limited to those elements, but may include other elements not expressly listed or inherent to such process, method, article, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical, physically, mechanical, or other manner.

### DETAILED DESCRIPTION OF EXEMPLARY EMBODIMENTS

In one embodiment, a construction panel system comprises a first panel of one or more construction panels. The first construction panel comprises a core board, a first insulation layer coupled to a first side of the core board, and a second insulation layer coupled to a second side of the core board, where the core board provides a structural integrity for the first panel, the first insulation layer substantially covers the first side of the core board and the second insulation layer substantially covers the second side of the core board.

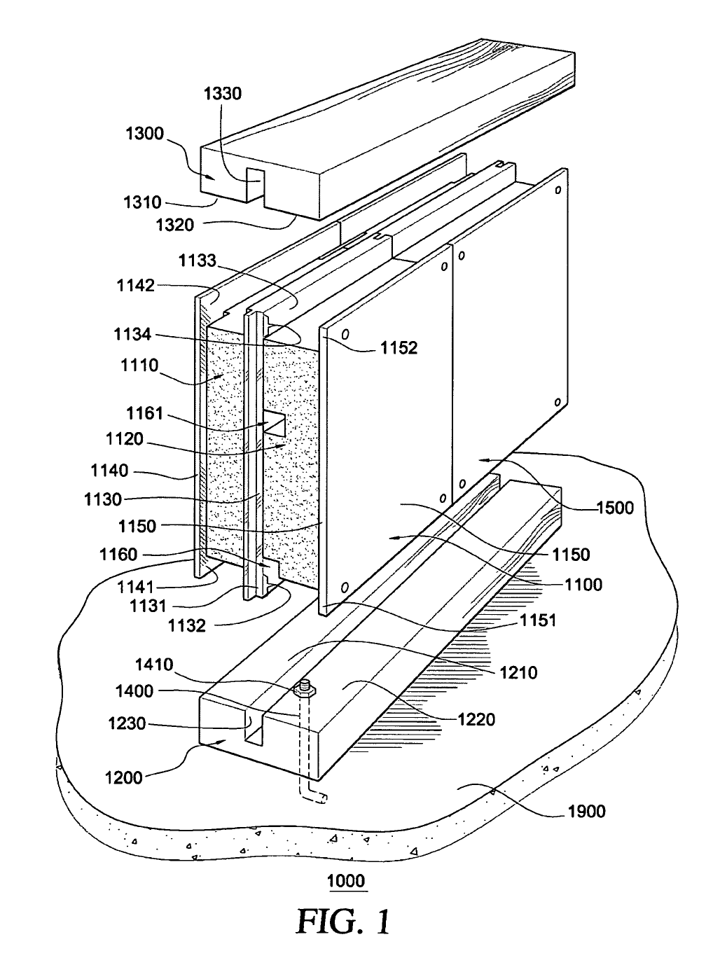

Turning to the drawings, FIG. 1 illustrates a top, side, front isometric view of construction panel system 1000, comprising construction panel 1100. The front view of FIG. 1 illustrates a sandwich layering of the different elements of construction panel 1100, comprising core board 1130, insulation layer 1110, and insulation layer 1120. Insulation layers 1110 and 1120 can be configured to establish desired R-values for insulation provided by construction panel 1100. In the present example, insulation layer 1110 substantially covers a first side of core board 1130, while insulation layer 1120 substantially covers a second side of core board 1130. Core board 1130 provides structural integrity for construction panel 1100, and can act similar to an I-beam to allow construction panel 1100 to bear loads and withstand compressive and tensile stresses. In the same or a different embodiment, core board 1130 can comprise a single solid piece and/or may not comprise holes. In some embodiments, core board 1130 comprises the central portion or web of the I-beam, where core board 1130 does not overlap to cover one or more ends of insulation layers 1110 and 1120. In other embodiments, core board 1130 can also comprise flanges to partially or fully overlap or cover one or more ends of insulation layers 1110 and 1120. In some examples, one or more of core board 1130 and insulation layers 1110 and 1120 can be configured to provide further structural integrity to construction panel 1100.

In one embodiment, insulation layers 1110 and 1120 can be coupled to both sides of core board 1130 using fasteners such as glue, tape, nails or screws. In a different embodiment, insulation layers 1110 and 1120 can be formed directly onto respective sides of core board 1130, where insulation layers 1110 and 1120 comprise one or more materials capable of adhering themselves to core board 1130 when cured.

In the present embodiment, core board 1130 of construction panel 1100 comprises an oriented strand board (OSB). In a different embodiment, core board 1130 can comprise one or more other materials, such as a plywood board, a Plycem® board, a honeycomb board, a metallic board, a composite board, and/or a plastic board. In some embodiments, core board 1130 may not be thermally conductive, and/or may comprise a thermal insulator.

In the present example, insulation layers 1110 and 1120 can comprise one or more types of insulation material such as a foam material, a polystyrene material, an Icynene® or polyicynene material, an aerogel material, a soy-based insulation material, and/or a polyurethane material, among others. In some embodiments, the polystyrene material can be expanded and/or extruded, and one or more types of insulation material can be injected and/or sprayed into place. Insulation layers 1110 and 1120 comprise the same type of insulation material. In a different embodiment, insulation layers 1110 and 1120 can comprise different types of insulation material.

In the example of FIG. 1, core board 1130 of construction panel 1100 comprises a thickness of approximately 0.75 inches or 1.9 centimeters (cm). Core board 1130 can also have other thicknesses greater or less than 0.75 inches or 1.9 cm. In the same or a different example, at least one of insulation layers 1110 and 1120 can comprise a minimum thickness of approximately 1 inch or 2.54 cm. In the same or a different example, at least one of insulation layers 1110 and 1120 can comprise a greater thickness of, for example, between approximately 2 inches or 5.08 cm, and 4 inches or 10.16 cm. In the same or a different embodiment, at least one of insulation layers 1110 and 1120 can comprise a density of between approximately 1 and 10 pounds per cubic foot or between approximately 16.02 and 160 kilograms per cubic meter.

Alternative thicknesses and densities for insulation layers 1110 and 1120 can be varied to achieve specific R-values for insulation. In addition, in some examples, such as when an exterior side of construction panel 1100 faces, is adjacent to, or is an exterior of a building and/or when construction panel system 1000 supports a structure such as a roof, the one of insulation layers 1100 and 1120 closer to the exterior can comprise an exterior thickness closer to the minimum thickness, and/or an exterior density closer to a heavier density of, for example, approximately 10 pounds per cubic foot. Such arrangement can allow core board 1130 to be positioned closer to the exterior to provide better structural support.

In the present example, construction panel 1100 of construction panel system 1000 also comprises siding panel 1140 coupled to insulation layer 1110 opposite core board 1130. Also in the present example, construction panel 1100 comprises siding panel 1150 coupled to insulation layer 1120 opposite core board 1130. In a different example, construction panel 1100 can comprise only one of siding panels 1140 and 1150. In such an example, one of insulation layers 1110 and 1120 can be exposed. In another example, construction panel 1100 can forego siding panels 1140 and 1150 altogether, while still comprising core board 1130 and insulation layers 1110 and 1120.

In the present embodiment, siding panels 1140 and 1150 substantially cover insulation layers 1110 and 1120, respectively. Siding panels 1140 and 1150 can be coupled to insulation layers 1110 and/or 1120 similar to the way insulation layers 1110 and 1120 couple to core board 1130, such as via fasteners like glue, tape, nails or screws, and/or by adhesion when insulation layers 1110 and/or 1120 cure onto siding panels 1140 and/or 1150. In the same or a different embodiment, siding panels 1140 and 1150 can comprise siding material comprising a Magnesiacore® or magnesium oxide board, a batten assembly, a lath screen, a stucco layer, an OSB, a plywood board, a gypsum board, a fiberglass mesh, a Kevlar® mesh, a carbon-fiber mesh, a fiber-cement layer, and/or a high density composite material. In the example of FIG. 1, siding panels 1140 and 1150 comprise similar siding material. In a different embodiment, siding panels 1140 and 1150 can comprise different siding material. In the same or a different embodiment, depending on the siding material used, siding panels 1140 and 1150 can also provide structural integrity for construction panel 1100 in conjunction with core board 1130.

The embodiment of FIG. 1 further illustrates chase 1161 traversed substantially parallel to core board 1130 through insulation layer 1110. Chase 1161 can be used, for example, to route wiring, tubing, and/or plumbing through construction panel 1100 and construction panel system 1000. In a different embodiment, a chase (not shown) similar to chase 1161 can be traversed through insulation layer 1120. Although chase 1161 is shown as substantially horizontal in FIG. 1, in the same or a different embodiment, construction panel 1100 can comprise a substantially vertical or diagonal chase (not shown) traversed parallel or non-parallel to core board 1130 through one of insulation layers 1110 and 1120.

As illustrated in FIG. 1, core board 1130 of construction panel 1100 comprises protrusion 1131 along a bottom end of core board 1130. In the present example, protrusion 1131 extends for protrusion distance 1132 beyond insulation layers 1110 and 1120. In a different example, protrusion 1131 can extend a first protrusion distance beyond insulation layer 1110, and a second protrusion distance beyond second insulation layer 1120. In another example, protrusion 1131 can be essentially flush with insulation layers 1110 and 1120, where protrusion distance 1132 would be negligible or non-existent.

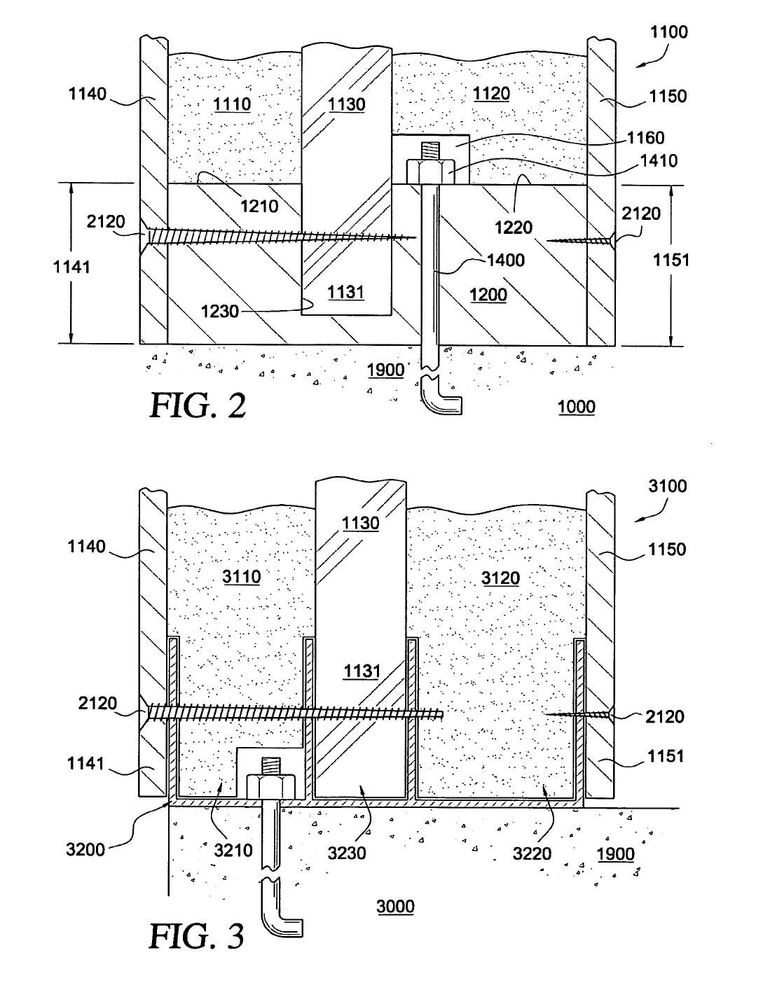

In the embodiment shown in FIG. 1, construction panel system 1000 further comprises plate 1200. FIG. 2 further illustrates a cross-sectional view of plate 1200 coupled to construction panel 1100. Plate 1200 can be used to provide a base on which construction panel 1100 can be supported, and/or through which construction panel 1000 can be coupled to base surface 1900. Base surface 1900 can be, for example, a ground or dirt surface, a concrete slab, and/or a floor of a building, among others. Plate 1200 comprises a groove 1230 along a length of plate 1200, and also comprises surfaces 1210 and 1220 along the length of plate 1200. Surfaces 1210 and 1220 run adjacent to opposite sides of groove 1230. In the present embodiment, a width of groove 1230 is complementary to a width of protrusion 1131 of core board 1130 of panel 1100. Similarly, a width of surface 1210 of plate 1200 is complementary to a width of insulation layer 1110 of construction panel 1100, while a width of surface 1220 of plate 1200 is complementary to a width of insulation layer 1120 of construction panel 1100.

Because plate 1200 couples to a bottom of construction panel 1100, the widths described above for plate 1200 are complementary to corresponding widths at the bottom of construction panel 1100. Accordingly, protrusion 1130 of construction panel 1100 is configured to fit within groove 1230 of plate 1200 when panel 1100 is coupled with and/or supported by plate 1200. In this embodiment, protrusion distance 1132 of protrusion 1131 would be less than or equal to a depth of groove 1230 of plate 1200.

FIG. 1 further illustrates construction panel system 1000 as comprising plate 1300. Plate 1300 can be similar to plate 1200, except that it couples to a top of construction panel 1100 and can be used, for example, to provide a top foundation on which other construction elements, such as roof structures and/or additional floor levels, can couple to the top of construction panel 1100. In the present example, core board 1130 of construction panel 1100 further comprises protrusion 1133 extending for protrusion distance 1134 beyond insulation layers 1110 and 1120. Protrusion 1133 of core board 1130 is similar to protrusion 1131, except that protrusion 1133 is located along a top end of core board 1130 and opposite protrusion 1131.

Plate 1300 is also similar to plate 1200 in that plate 1300 comprises a groove 1330 along a length of plate 1300, similar to groove 1230 of plate 1200. In the present example, plate 1300 also comprises surfaces 1310 and 1320 along a length of plate 1300, similar to surfaces 1210 and 1220 of plate 1200. A width of groove 1330 of plate 1300 is complementary to a width of protrusion 1133 of core board 1130. Protrusion distance 1134 of protrusion 1133 is less than or equal to a depth of groove 1330, and/or protrusion 1133 is configured to fit within groove 1330 when plate 1300 is coupled to construction panel 1100.

The illustration in FIG. 1 shows an assembled portion of construction panel system 1000. The illustration in FIG. 2 shows construction panel 1100 coupled to and supported by plate 1200 at the bottom. Plates 1200 and 1300 of construction panel system 1000 can comprise different materials, including but not limited to a dimensional lumber material, an engineered wood material, a pressure treated wood material, a metal material such as extruded metal or roll-formed metal, and/or a plastic material such as vinyl.

Returning to siding panel 1140 in FIGS. 1 and 2, siding panel 1140 comprises siding protrusion 1141 extended past insulation layer 1110 at the bottom of construction panel 1100. In the same example, siding panel 1140 also comprises siding protrusion 1142 extended past insulation layer 1110 at the top of construction panel 1100. In the present example, siding protrusion 1141 is configured to couple to and at least partially cover a side of plate 1200, while protrusion 1142 is configured to couple to and at least partially cover a side of plate 1300. Fasteners such as screws 2120 and/or glue, tape or nails can be used to couple siding protrusions 1141 and/or 1142 to plates 1200 and/or 1300, respectively. In one embodiment, siding protrusion 1141 is substantially equal to a height of plate 1200. In the same or a different embodiment, siding protrusion 1142 is substantially equal to a height of plate 1300.

The example shown in FIG. 1 shows construction panel 1100 comprising siding panel 1150. Similar to siding panel 1140, siding panel 1150 comprises siding protrusion 1151 extended past insulation layer 1120 at the bottom of construction panel 1100, as further illustrated in FIG. 2. In the same example, siding panel 1150 also comprises siding protrusion 1152 extended past insulation layer 1120 at the top of construction panel 1100. Siding protrusions 1151 and 1152 can couple to plates 1200 and 1300, respectively, similar to as described above for siding protrusions 1141 and 1142.

Continuing with the example of FIGS. 1-2, construction panel system 1000 can further comprise anchor bolts 1400 comprising anchor bolt head 1410. Anchor bolt 1400 can be an example of one or more anchor bolts with corresponding anchor bolt heads. In FIG. 1, anchor bolt 1400 is depicted in dashed lines to illustrate the fact that anchor bolt 1400 is shown inserted into plate 1200. Anchor bolt 1400 is configured to traverse at least one of surfaces 1210 and 1220 of plate 1200 to secure plate 1200 to base surface 1900. In the present example, anchor bolt 1400 is shown traversing plate 1200 from surface 1210 at a top side of plate 1200 to a bottom side of plate 1200, where anchor bolt 1400 couples to base surface 1900.

In cases such as shown in FIGS. 1-2, where anchor bolt head 1410 protrudes above the top side of plate 1200, construction panel 1100 can be configured to comprise anchor bolt slot 1160 along a bottom side of at least one of insulation layers 1110 and 1120. Anchor bolt slot 1160 is configured to accommodate anchor bolt head 1400 when protrusion 1131 of construction panel 1100 is coupled to groove 1230 of plate 1200.

Continuing with the Figures, FIG. 3 illustrates a cross-sectional view of plate 3200 of construction panel system 3000, similar to plate 1200 and construction panel system 1000 respectively, as described for FIGS. 1-2. Plate 3200 differs from plate 1200 by comprising grooves 3210 and 3220 instead of surfaces 1210 and 1220. FIG. 3 also illustrates construction panel 3100 comprising insulation layers 3110 and 3120 coupled to core board 1130 and to plate 3200. Insulation layers 3110 and 3120 are similar to insulation layers 1110 and 1120 of FIGS. 1-2, but differ by comprising reduced widths at the bottom where insulation layers 3110 and 3120 couple to plate 3200. Grooves 3210 and 3220 are configured to accommodate the reduced widths of insulation layers 3110 and 3120, respectively, when construction panel 1100 couples with plate 3200. In the same or a different embodiment, another plate (not shown) can be similar in design to plate 3200 while serving a function similar to plate 1300 of FIG. 1 when coupled to the top of construction panel 3100.

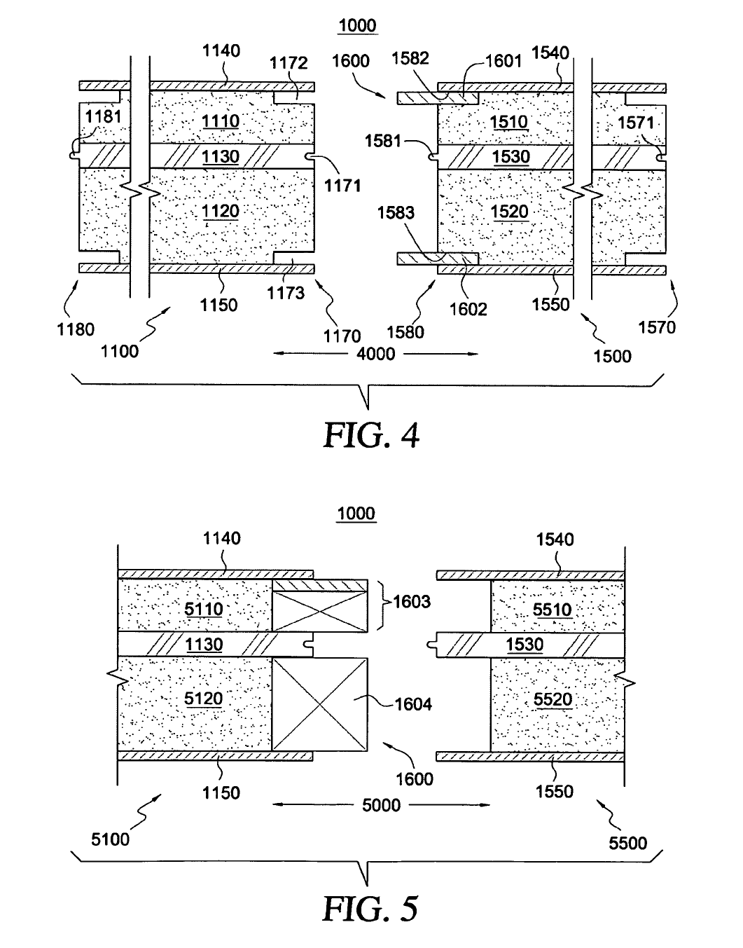

Continuing with the Figures, FIG. 4 illustrates a top view of construction panel system 1000, showing construction panel 1100 aligned to be coupled to construction panel 1500. Construction panel 1500, also depicted in FIG. 1 as already coupled to construction panel 1100, can be similar to construction panel 1100 and comprises insulation layers 1510 and 1520 coupled to opposite sides of core board 1530.

As illustrated in FIG. 4, construction panel 1100 comprises groove 1171 along a groove end 1170 of construction panel 1100. Similarly, construction panel 1500 comprises a tab 1581 along a tab end 1580. In at least one example, tab end 1580 and groove end 1170 can be referred to as linkage ends. In the present example, groove 1171 is formed within a thickness of core board 1130 along groove end 1170 of construction panel 1100, while tab 1581 is formed within a thickness of core board 1530 along tab end 1580 of construction panel 1500. In a different example, tab 1581 can be formed by core board 1530 itself along tab end 1580, while groove 1171 can comprise a void between insulation layers 1110 and 1120 and along groove end 1170, where core board 1130 does not reach groove end 1170 of construction panel 1100.

Groove 1171 of construction panel 1100 is complementary to tab 1581 of construction panel 1500, and both are configured to couple together when construction panel 1100 is coupled with panel 1500 along groove end 1170 and tab end 1580. In the same or a different example, construction panel 1100 can comprise a tab 1181 along a tab end 1180 opposite to groove end 1170, while construction panel 1500 can comprise a groove 1571 along a groove end 1570 opposite to tab end 1581. In at least one example, tab end 1180 and groove end 1570 can also be referred to as linkage ends.

FIG. 5 illustrates a top view of a portion of construction panel system 1000, showing construction panel 5100 aligned to be coupled to construction panel 5500 at a load-bearing junction. Construction panel 5100 is similar to construction panel 1100, but comprises insulation layers 5110 and 5120 instead of insulation layers 1110 and 1120, respectively. In addition, construction panel 5500 is similar to construction panel 1500, but comprises insulation layers 5510 and 5520 instead of insulation layers 1510 and 1520, respectively. In the example of FIG. 5, insulation layers 5110, 5120, 5510, and 5520 differ from insulation layers 1110, 1120, 1510, and 1520 in FIG. 4, respectively, by not extending through to the linkage ends of their respective construction panels.

In the examples shown in FIG. 4-5, construction panel system 1000 further comprises linkage structures 1601-1604 of one or more linkage structures 1600. Linkage structures 1600 can be used to safeguard, weatherproof, and/or add structural integrity to joints between construction panels 1100 and 1500 and between construction panels 5100 and 5500. Linkage structures 1601-1602 are configured to fit between insulation layers 1110 and 1510, and/or between insulation layers 1120 and 1520 of construction panels 1100 and 1200, respectively, in FIG. 4. Similarly, linkage structures 1603-1604 are configured to fit between insulation layers 5110 and 5510, and/or between insulation layers 5120 and 5520 of construction panels 5100 and 5500, respectively, in FIG. 5.

Linkage structures 1600 can comprise at least one of a spline and a structural post configured to bear loads. For example, linkage structures 1603 and 1604 in FIG. 5 differ from linkage structures 1601 and 1602 in FIG. 4 by comprising load bearing posts, where linkage structures 1601 and 1602 comprise only splines. In addition, linkage structure 1603 in FIG. 5 further comprises a spline alongside its load bearing post. Other combinations of linkage structures are possible in other embodiments. In addition, in embodiments comprising weatherproof splines, linkage structures 1600 can protect the joints between construction panels 1100 and 1500 and/or between construction panels 5100 and 5500 from the elements.

As illustrated in FIG. 4, in order to accommodate linkage structure 1601, insulation layer 1110 of construction panel 1100 comprises linkage slot 1172 along the linkage end of construction panel 1100. Similarly, insulation layer 1510 of construction panel 1500 comprises linkage slot 1582 along the linkage end of construction panel 1500. A first end of linkage structure 1601 is configured to couple with linkage slot 1172 along the linkage end of construction panel 1100 when construction panels 1100 and 1500 are coupled together. Similarly, a second end of linkage structure 1601 is configured to couple with linkage slot 1582 along the linkage end of construction panel 1500 when construction panels 1100 and 1500 are coupled together.

Similar to as described for linkage structure 1601, linkage structure 1602 in FIG. 4 is configured to couple to linkage slot 1173 along the linkage end of construction panel 1100, and to linkage slot 1583 along the linkage end of construction panel 1500. Other similar configuration are possible at opposite ends to the linkage ends of construction panels 1100 and/or 1500.

With respect to FIG. 5, linkage structure 1603 can be coupled between construction panels 5100 and 5500 much as described above for linkage structure 1601 with respect to construction panels 1100 and 1500. Similarly, linkage structure 1604 can be coupled between construction panels 5100 and 5500 much as described above for linkage structure 1602.

In embodiments where construction panel system 1000 comprises siding panels, such as in FIGS. 4-5 for siding panels 1140, 1150, 1540, and 1550, the relationship between the siding panels and insulation layers 1110, 1120, 1510, and 1520 of construction panels 1100 and 1500 can be adjusted to accommodate different types of linkage structures. For example, in FIG. 4, insulation layers 1110, 1120, 1510, and 1520 comprise substantially similar widths along axis 4000 to siding panels 1140, 1150, 1540, and 1550, respectively, extending through to the respective linkage ends of construction panels 1100 and 1500. In contrast, in the example of FIG. 5, insulation layers 5110, 5120, 5510, and 5520 comprise lesser widths along axis 5000 than siding panels 1140, 1150, 1540, and 1550, respectively, and do not extend through to the respective linkage ends of construction panels 5100 and 5500.

Although the examples of FIGS. 4-5 show construction panels with pre-formed linkage ends, such as linkage ends 1170 and 1580, in other examples such pre-formed linkage ends may not exist for some construction panels, including situations where construction panels were cut in the field. Linkage ends can still be formed in the field for such construction panels, however. As an example, linkage slots similar to as illustrated in FIGS. 4-5 can be formed within the insulation layers of such construction panels to accommodate linkage structures similar to linkage structures 1600 (FIGS. 4-5). The linkage slots can be formed into the insulation layers using tools such as hot knifes, rotary tools, and/or other tools capable of gouging, cutting, and/or melting through the insulation layers. In addition, where the core boards of the construction panels did not comprise complementary tabs and grooves, such as tab 1581 and groove 1171 (FIG. 4), the core boards of the construction panels can still be securely coupled together via a linkage structure such as linkage structure 1603 (FIG. 5). In such a situation, fasteners such as nails, bolts, or glue could be used to couple the linkage structure to the respective core boards of both construction panels.

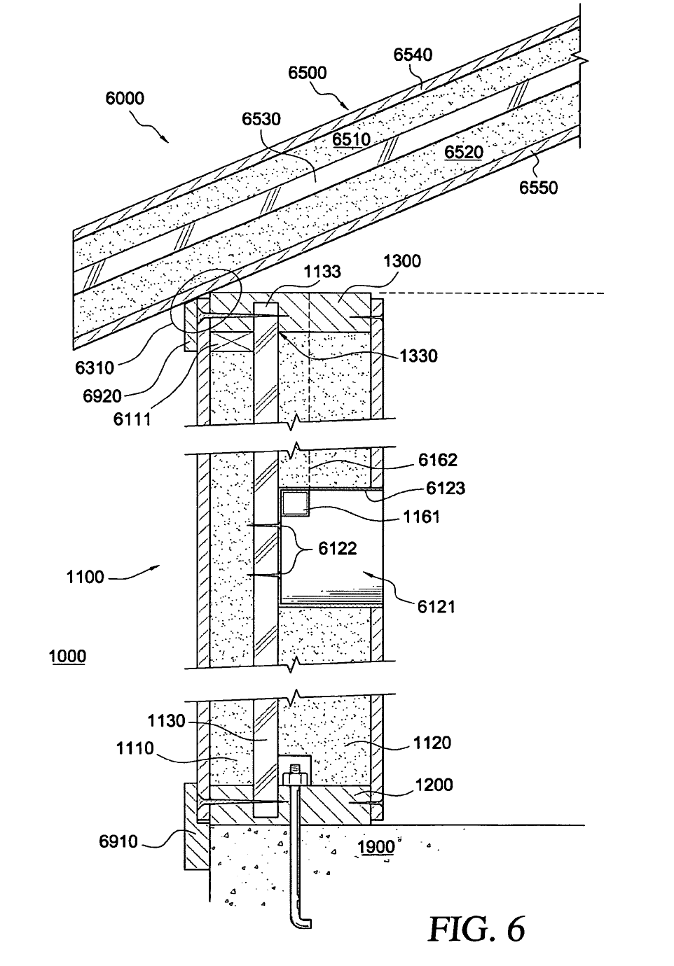

Continuing with the figures, FIG. 6 illustrates a side cross-sectional view of construction panel system 1000 comprising a roof structure 6000 coupled to construction panel 1100.

In the present embodiment shown in FIG. 6, roof structure 6000 comprises a roof panel 6500 similar to construction panel 1100. Roof panel 6500 comprises a core board 6530 and insulation layers 6510 and 6520, which can be similar to core board 1130 and insulation layers 1110 and 1120 of construction panel 1100, respectively. In the present example, roof panel 6500 further comprises siding panels 6540 and 6550, which can be similar to siding panels 1140 and 1150 of construction panel 1100, respectively. In other embodiments, roof structure can comprise other structures dissimilar to construction panel 1100.

As illustrated in FIG. 6, roof structure 6000 is coupled to plate 1300 at roof contact area 6310. Plate 1300 is coupled to construction panel 1100 as previously described, having protrusion 1133 of core board 1130 coupled to groove 1330. Core board 1130 of construction panel 1100 is configured to support at least part of a load of roof structure 6000 when roof structure 6000 is borne by construction panel 1100. In the present example, the load of roof structure 6000 is transmitted to core board 1130 of construction panel 1100 via plate 1300.

As can be seen in the illustration of FIG. 6, a thickness of insulation layer 1120 is greater than a thickness of insulation layer 1110 in construction panel 1100. In the present example, such a difference in thickness allows core board 1130 to be positioned closer to an exterior side of construction panel 1100 and to contact area 6310 at plate 1300, where a greater proportion of the load of the roof structure 6000 is exerted. Such an arrangement allows the load of roof structure 6000 to be more effectively transferred to and supported by core board 1330. In the same or a different example, the density of insulation layer 1110 can be greater than for insulation layer 1120, closer to approximately 10 pounds per square foot, for example, to compensate for the smaller thickness and/or to add to the structural support provided by construction panel 1100. In some embodiments, as illustrated in FIG. 6, compression block 6111 can be located between plate 1300 and at least one of insulation layers 1110 and 1120 in order to bolster the bearing of the load of roof structure 6000.

Although FIG. 6 illustrates roof contact area 6310 as bearing a rafter roof structure 6000, in the same or a different embodiment plate 1300 can be configured to support other roof structures or portions thereof, such as trusses or scissor trusses.

FIG. 6 further illustrates an electrical box aperture 6121 coupled to first panel 1100 through at least one insulation layer 1120. In a different example, electrical box aperture 6121 can be configured to couple through insulation layer 1110. In the present embodiment, electrical box aperture 6121 is configured to couple with chase 1161 and vertical chase 6162 of construction panel 1100. In addition, electrical box aperture 6121 is configured to expose core board 1130 through insulation layer 1120. When exposed as such, core board 1130 is capable of supporting an electrical box 6123 attached to core board 1130 via fasteners such as fasteners 6122 illustrated in FIG. 6.

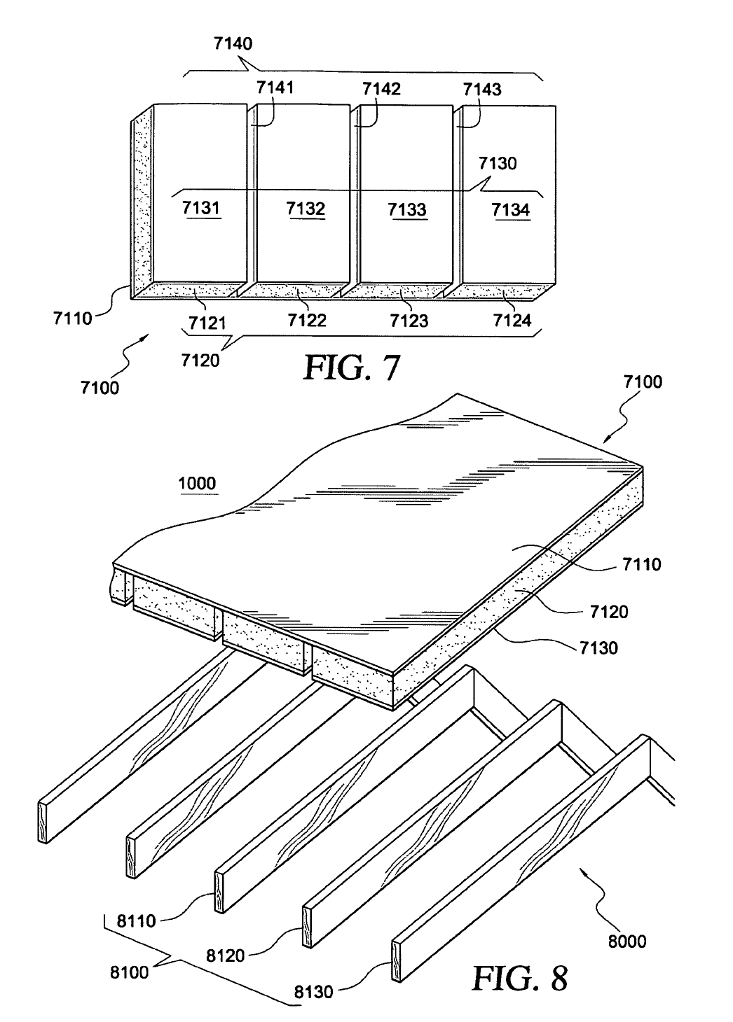

Continuing with the figures, FIG. 7 illustrates an isometric view of roof sheathing 7100 capable of being used with a roof structure (not shown). FIG. 8 illustrates a view of roof sheathing 7100 aligned for coupling with roof structure 8000. Roof sheathing 7100 comprises sheathing board 7110 and two or more insulation sections 7120 configured to couple with and substantially cover an insulated side of sheathing board 7110. In the embodiment of FIG. 7, insulation sections 7120 comprise insulation sections 7121-7124. As shown in the present example, roof sheathing 7100 can further comprise one or more facing panels 7130 configured to couple with and substantially cover at least one of insulation sections 7120. In the present example, facing panels 7131-7134 cover insulation sections 7121-7124, respectively. Finally, roof sheathing 7100 comprises one or more roof slots 7140 parallel to an end of sheathing board 7110 and located between insulation sections 7120. In the present example, roof slots 7141-7143 evenly separate insulation sections 7121-7124.

Roof sheathing 7100 is similar to construction panel 1100 in that sheathing board 7110 can be coupled to insulation sections 7120 comparable to the way core board 1130 couples to insulation layers 1110 and 1120 in construction panel 1100. Similarly, facing panels 7310 can be coupled to insulation sections 7120 comparable to the way siding panels 1140 and 1150 couple to insulation layers 1110 and 1120 in construction panel 1100. In addition, sheathing board 7110 can comprise materials or manufacture similar to those of core board 1130 of construction panel 1100. Likewise, insulation sections 7120 can comprise materials or manufacture similar to those of insulation layers 1110 and 1120. In cases where roof sheathing 7100 comprises facing panels 7310, facing panels 7310 can comprise materials or manufacture similar to those of siding panels 1140 and/or 1150 in construction panel 1100.

In the example of FIG. 7, roof panel 7110 comprises a length of approximately 8 feet or 2.44 meters and a width of approximately 4 feet or 1.22 meters, while insulation sections 7120 comprise a width of approximately 2 feet or 0.61 meters, and roof slots 7140 comprise a thickness of approximately 2 inches or 5.08 cm. These dimensions can make roof panel 7110 comparable to standard dimensions of other non-insulated roof panels in use in the construction industry. However, other dimensions are possible for roof panel 7110.

As shown in FIG. 8, roof sheathing 7100 can be positioned atop roof structure 8000 to provide insulation for an interior side of roof structure 8000. In one example, the interior side of roof structure 8000 can comprise an attic. Roof structure 8000 comprises rafters 8100 substantially parallel to each other atop roof structure 8000, where a thickness of rafters 8100 is complementary to the thickness of roof slots 7140 of roof sheathing 7100. The insulated side of sheathing board 7110 of roof sheathing 7100 can be aligned to couple atop roof structure 8000, where individual ones of roof slots 7140 are configured to accommodate individual ones of rafters 8100 of roof structure 8000, thus positioning insulation sections 7120 of roof sheathing 7100 between rafters 8100. In the present example of FIG. 8, roof slots 7141-7143 can be used to accommodate rafters 8110, 8120, and 8130 when roof sheathing 7100 is positioned atop roof structure 8000. In a different embodiment, a roof structure can comprise trusses instead of rafters 8100 while still being compatible with roof sheathing 7100.

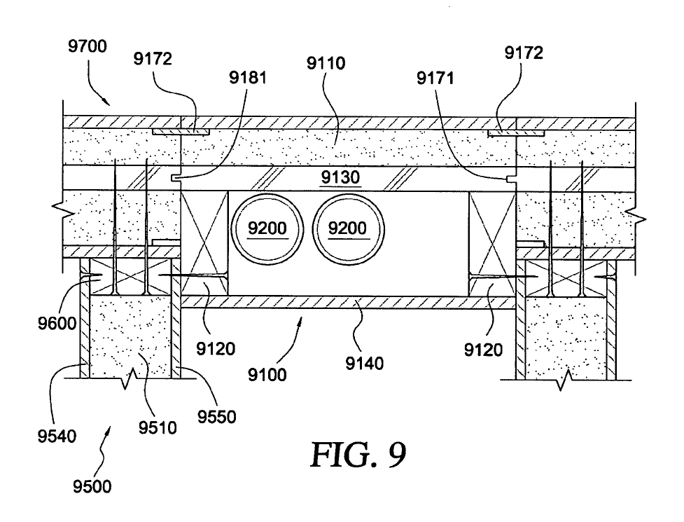

Moving along, FIG. 9 illustrates a top view of plumbing panel 9100 coupled to other construction panels of construction panel system 1000. Plumbing panel 9100 comprises core board 9130, insulation layer 9110 coupled to one face of core board 9130, at least two posts 9120 coupled along opposite ends of another face of core board 9100, and siding panel 9140 having opposite ends coupled along the at least two posts 9120. Core board 9130, insulation layer 9110, and siding panel 9140 can be similar to core board 1130, insulation layers 1110 and 1120, and siding panels 1140 and 1150, respectively, of construction panel 1100 (FIG. 1). Plumbing panel 9100 is configured to create a void between core board 9130 and siding panel 9140 through which plumbing 9200 can be routed. In the same or a different example, the void between core board 9130 and siding panel 9140 can be filled with material such as spray-in foam for insulation.

As illustrated in FIG. 9, plumbing panel 9100 can also comprise groove 9171, tab 9181, and/or linkage slots 9172 similar to groove 1171, tab 1181, and/or linkage slot 1172 of construction panel 1100, respectively, to couple with the other construction panels of construction panel system 1000 similar to as described above for construction panels 1100 and 1500 (FIG. 4-5). In the present embodiment, a thickness of the void between core board 9130 and siding panel 9140 is greater than a thickness of collinear insulation sections of the other construction panels of construction panel system 1000. In a different embodiment, there may not be such difference in thicknesses.

FIG. 9 also illustrates a top view of interior panel 9500 coupled to panel 9700 of construction panel system, where panel 9700 can be similar to panel 1100 (FIG. 1). In the present embodiment, interior panel 9500 comprises a single insulation layer 9510 sandwiched between siding panels 9540 and 9550. Insulation layer 9510 can be similar to insulation layers 1110 and/or 1120 (FIG. 1), and siding panels 9540 and 9550 can be similar to siding panels 1140 and/or 1150 of panel 1100 (FIG. 1). In the same or a different embodiment, interior panel 9500 can be non-load-bearing. In a different embodiment, interior panel 9500 could be further similar to panel 1100 (FIG. 1) by also comprising a core board similar to core board 1130.

In the present example, interior panel 9500 is coupled to panel 9700 via linkage structure 9600, where linkage structure 9600 can be similar to the structural posts described for linkage structures 1600 (FIGS. 4-5). As illustrated in FIG. 9, linkage structure 9600 can be coupled laterally to panel 9700 using fasteners reaching through linkage structure 9600 to the core board of panel 9700. In the present example, siding panels 9540 and 9550 of interior panel 9500 protrude past insulation layer 9510, leaving a linkage slot that can accommodate linkage structure 9600 between siding panels 9540 and 9550 at an end of interior panel 9500. Interior panel 9500 can be coupled to panel 9700 by aligning linkage structure 9600 within the linkage slot of interior panel 9500. In turn, interior panel 9500 can be secured to linkage structure 9600 with fasteners through siding panels 9540 and 9550 to linkage structure 9600.

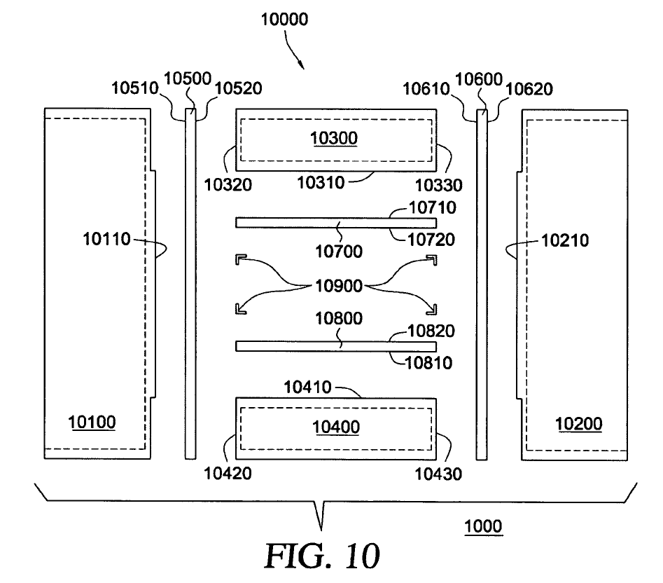

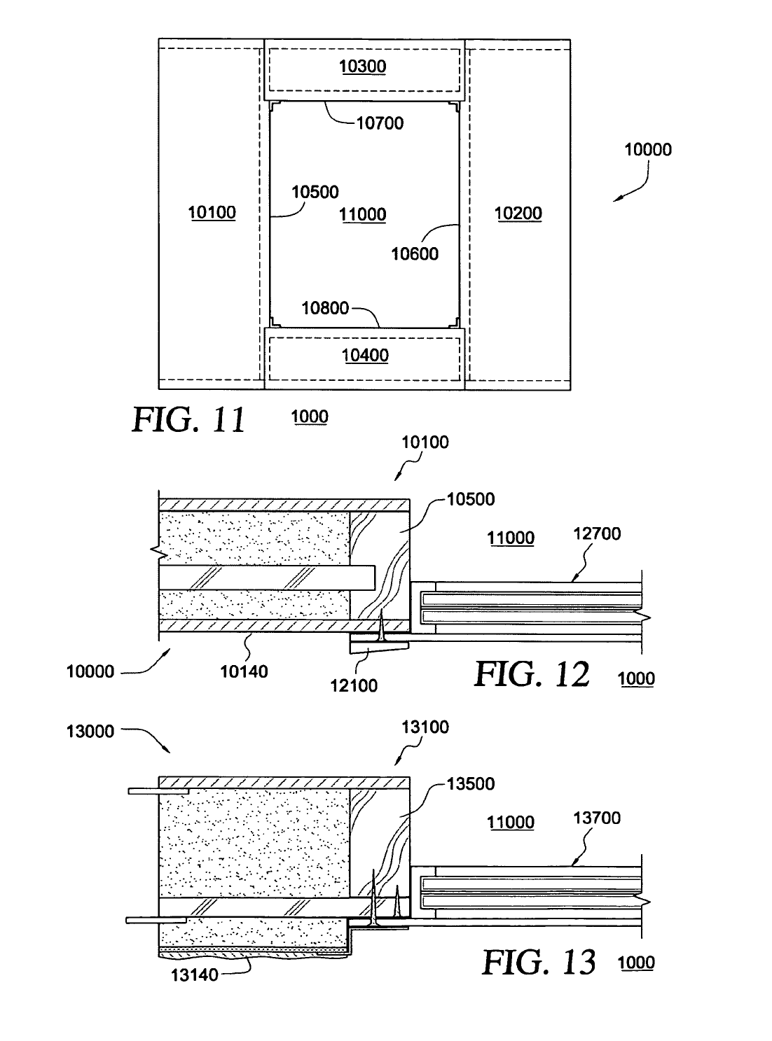

Going forward, FIG. 10 illustrates different elements aligned to assemble a wall-opening structure 10000 of construction panel system 1000. FIG. 11 illustrates wall-opening structure 10000 as assembled. Wall-opening structure 10000 can be used to create an opening that can be used, for example, to attach windows to construction panel system 1000.

Wall-opening structure 10000 can comprise construction panels 10100, 10200, 10300, and 10400, similar to construction panel 1100 of FIG. 1. In the embodiment of FIG. 10, construction panels 10100 and 10200 are larger than construction panels 10300 and 10400, and such difference in size allows opening 11000 to be formed when construction panels 10100, 10200, 10300, and 10400 are coupled together. In addition, wall-opening structure 10000 comprises bucks 10500, 10600, 10700, and 10800. In the present embodiment, wall-opening structure 10000 also comprises brackets 10900 configured to couple one or more junctions between different ones of bucks 10500, 10600, 10700, and 10800.

The different elements of wall-opening structure 10000 are configured to couple together as follows, where bucks 10500, 10600, 10700, and 10800 couple along respective linkage ends of construction panels 10100, 10200, 10300, and 10400. End 10110 of construction panel 10100 is configured to couple along side 10510 of buck 10500. End 10210 of construction panel 10200 is configured to couple along side 10620 of buck 10600. End 10320 of construction panel 10300 is configured to couple to side 10520 of buck 10500 at a top portion of buck 10500. End 10420 of construction panel 10400 is configured to couple to side 10520 of buck 10500 at a bottom portion of buck 10500. End 10330 of construction panel 10300 is configured to couple to side 10610 of buck 10600 at a top portion of buck 10600. End 10430 of construction panel 10400 is configured to couple to side 10610 of buck 10600 at a bottom portion of buck 10600. End 10310 of construction panel 10300 is configured to couple to side 10710 of buck 10700. End 10410 of construction panel 10400 is configured to couple to side 10810 of buck 10800. Buck 10500 is configured to accommodate the core board of construction panel 10100, the core board of construction panel 10300, and the core board of construction panel 10400. Buck 10600 is configured to accommodate the core board of construction panel 10200, the core board of construction panel 10300, and the core board of construction panel 10400. Buck 10700 is configured to accommodate the core board of construction panel 10300. Finally, buck 10800 is configured to accommodate the core board of construction panel 10400.

When coupled as described above, the elements of wall-opening structure 10000 can combine as shown in FIG. 11. In the present embodiment, bucks 10500 and 10600 comprise widths of approximately 1.5 inches or 3.8 cm, while the linkage ends of construction panels 10100, 10200, 10300, and 10400 comprise linkage slots approximately 0.75 inches or 1.9 cm deep. As a result, the widths of bucks 10500 and 10600 are shared between the linkage ends of construction panels 10100, 10200, 10300, and 10400. In a location where a side of one of bucks 10500, 10600, 10700, and 10800 faces opening 11000, the linkage end of construction panels 10100, 10200, 10300, and 10400 opposite such locations may extend to cover the width of the one of bucks 10500 and 10600. In the present embodiment, brackets 10900 are also shown coupled to the different junctions between bucks 10500, 10600, 10700, and 10800. Such an arrangement allows brackets 10900 to add additional support for wall-opening structure 10000.

FIG. 12 illustrates a top cross-sectional view of a portion of wall-opening structure 10000 coupled with window 12700. In the present example, construction panel 10100 comprises a siding panel 10140 of fiber-cement, although other materials are possible. In the same or a different example, siding panel 10140 can comprise lath or mesh of materials such as metal, cloth, and/or fiber glass, where the lath or mesh can be configured for on-site stucco application. Buck 10500 is shown coupled to an end of construction panel 10100 while accommodating the core board of construction panel 10100. In turn, window 12000 couples to construction panel 10100 along a side of opening 11000. The coupling between window 12000 and construction panel 10100 can be covered with trim 12100.

FIG. 13 illustrates a top cross-sectional view of a portion of wall-opening structure 13000 coupled with window 13700, where wall-opening structure 13000 comprises a stucco exterior. In the present example, construction panel 13100 comprises a siding panel 13140 comprising stucco, and a buck 13500 coupled to a linkage end of construction panel 13100. Construction panel 13100 also comprises in the present embodiment a reveal along the linkage end, where siding panel 13140 and/or an insulation layer of construction panel 13100 do not cover the core board of construction panel 13100. In turn, window 13700 couples along a side of opening 11000 to construction panel 13100, where one or more fasteners couple window 13700 along the reveal to the core board and/or to buck 13500 of construction panel 13100.

Although wall opening 11000 can be formed following the examples of FIGS. 10-13, in a different embodiment a cut wall opening similar to wall opening 11000 can also be formed in the field by cutting a wall opening periphery through one or more construction panels similar to construction panel 1100. In one such embodiment, bucks similar to bucks 10500, 10600, 10700, and 10800 of wall-opening structure 10000 can be positioned along the wall opening periphery to add any necessary structural support. In the same or a different embodiment, the wall opening periphery can span more than one of the construction panels.

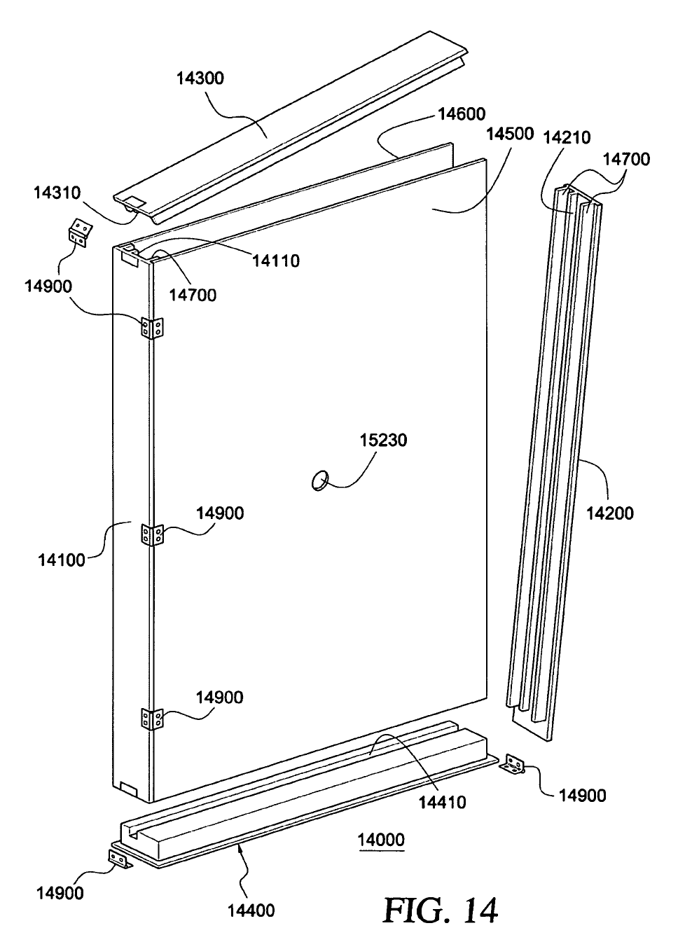

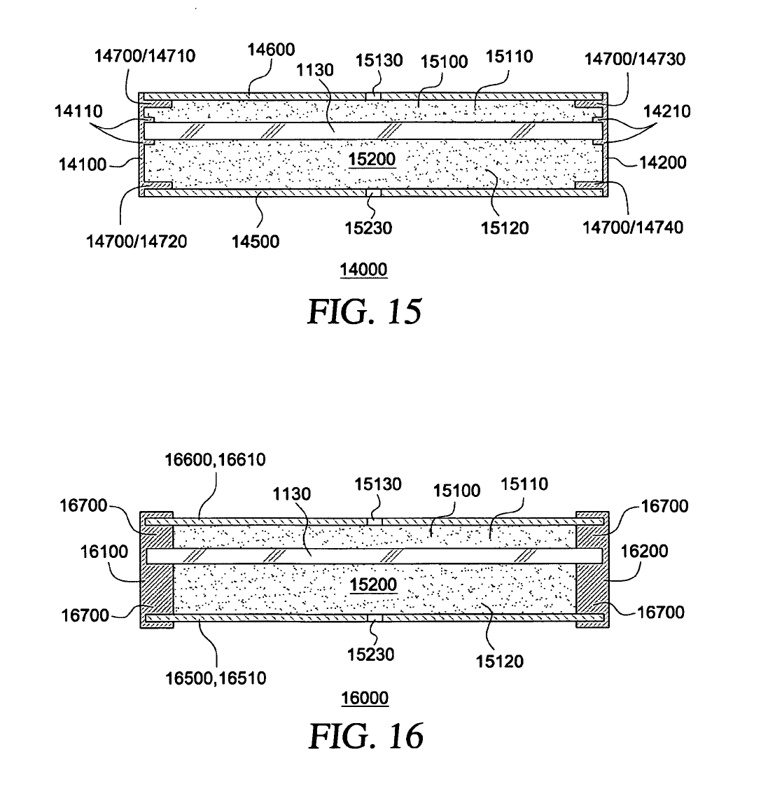

Continuing with the figures, FIG. 14 illustrates a partially exploded isometric view of a panel-form 14000 configured to manufacture and/or assemble a construction panel. FIG. 15 illustrates a top cross-sectional view of panel-form 14000. In examples such as the present one, the construction panel can be construction panel 1100 (FIG. 1), comprising core board 1130 and insulation layers 1110 and 1120. In the present example, insulation materials 15110 and 15120 can be used to form insulation layers such as insulation layers 1110 and 1120 (FIG. 1), respectively, of construction panel 1100.

In the present example of FIGS. 14-15, panel-form 14000 comprises wall 14100 comprising core-guide 14110, wall 14200 facing wall 14100 and comprising core-guide 14210 substantially parallel to core-guide 14110, wall 14300 comprising core-guide 14310, wall 14400 facing wall 14300 and comprising core-guide 14410 substantially parallel to core-guide 14310, wall 14500, wall 14600 facing wall 14500, insulation division 15100 inside panel-form 14000, and insulation division 15200 inside panel-form 14000.

FIG. 14 illustrates how walls 14100, 14200, 14300, 14400, 14500, and 14600 can be configured to be coupled together in a box formation, where core-guides 14110, 14210, 14310, and 14410 are configured to face an interior of the box formation. As shown in the present embodiment, walls 14100, 14200, 14300, 14400, 14500, and 14600 can be held in the box formation through a set of hinges 14900 designed to also allow one or more of walls 14100, 14200, 14300, 14400, 14500, and 14600 to be opened for access to the interior of the box formation.

In the embodiment of FIGS. 14-15, as better illustrated in FIG. 15, panel-form 14000 is configured to accommodate core board 1130 via core-guides 14110, 14210, 14310 and 14410. As a result, core-guides 14110, 14210, 14310 and 14410 are complementary to first, second, third, and fourth ends of core board 1130. First, second, third, and fourth ends of core board 1130 can correspond, for example, to protrusions 1131 and 1133 of core board 1130 (FIG. 1), and/or to portions of core board 1130 along linkage ends of construction panel 1100 (FIGS. 4-5). When coupled to core-guides 14110, 14210, 14310, and 14410 within panel-form 14000, core board 1130 is configured to divide the interior of the box formation of panel-form 14000 between insulation divisions 15100 and 15200.

In the present example, as shown in FIG. 15, insulation division 15100 comprises insertion point 15130, while insulation division 15200 comprises insertion point 15230. In the present example insertion points 15130 and 15230 are shown located at walls 14600 and 14500, respectively. In another example insertion points 15130 and 15230 could be located in other walls of panel-form 14000 leading to the respective insulation divisions 15100 and 15200 of insertion points 15130 and 15230. In a different example, insertion points 15130 and 15230 could simply comprise exposed portions of insulation divisions 15100 and 15200, respectively, accessible when one of walls 14100-14600 has not been completely attached to the box formation of construction panel 14000.

Insulation divisions 15100 and 15200 are configured to shape and/or contain insulation materials 15110 and 15120 when inserted through insertion points 15130 and 15230, respectively. In the present example, once inserted into panel-form 14000, insulation materials 15110 and 15120 solidify into a desired shape defined by insulation divisions 15100 and 15200 and couple to opposite sides of core board 1130 as during a curing process.

In the same or a different example, one or more of walls 14100, 14200, 14300, 14400, 14500 and 14600, such as walls 14500 and/or 14600, can comprise a textured design facing the interior of the box formation of panel-form 14000. The textured design can be used to texture one or more of insulation materials 15110 and/or 15120 when shaped by panel-form 14000 during the curing process. The textured design can comprise, for example, one or more of a wood grain pattern, a stone pattern, a brick pattern, a block pattern, an adobe pattern, or simply a smooth surface, among others.

FIG. 16 illustrates a top cross-sectional view of panel-form 16000, similar to panel-form 14000 of FIGS. 14-15. Panel-form 16000 comprises walls 16100, 16200, 16500, and 16600, similar to walls 14100, 14200, 14500, and 14600, respectively, of panel-form 14000. In the present example, walls 16500 and 16600 comprise siding panels 16510 and 16610 configured to couple to insulation materials 15110 and 15120, respectively. Siding panels 16510 and 16610 can be similar to siding panels 1140 and 1150 of construction panel 1100 (FIG. 1). Construction form 16000 can thus be used to assemble and/or manufacture construction panels with pre-attached siding panels.

As illustrated in FIGS. 15-16, panel-forms 14000 and 16000 comprise one or more linkage structure molds 14700 and 16700, respectively. Linkage structure molds 14700 and 16700 can be used to shape insulation materials 15110 and/or 15120 to correspond to the shape or form of linkage structures used to link adjacent construction panels. For example, linkage structure molds 14700 and/or 16700 can correspond to the shape or form of one or more of linkage structures 1601-1604 shown in FIGS. 4-5. As an example, for FIG. 15, linkage structure mold 14710 and 14720 are positioned along a side of panel-form 14000, where linkage structure mold 14710 is adjacent to walls 14100 and 14600, and linkage structure mold 14720 is adjacent to walls 14100 and 14500. Similarly, linkage structure molds 14730 and 14740 are positioned along another side of panel-form 14000, where linkage structure mold 14730 is adjacent to walls 14200 and 14600, and linkage structure mold 14740 is adjacent to walls 14200 and 14500. A similar arrangement is shown for linkage structure molds 16700 in FIG. 16.

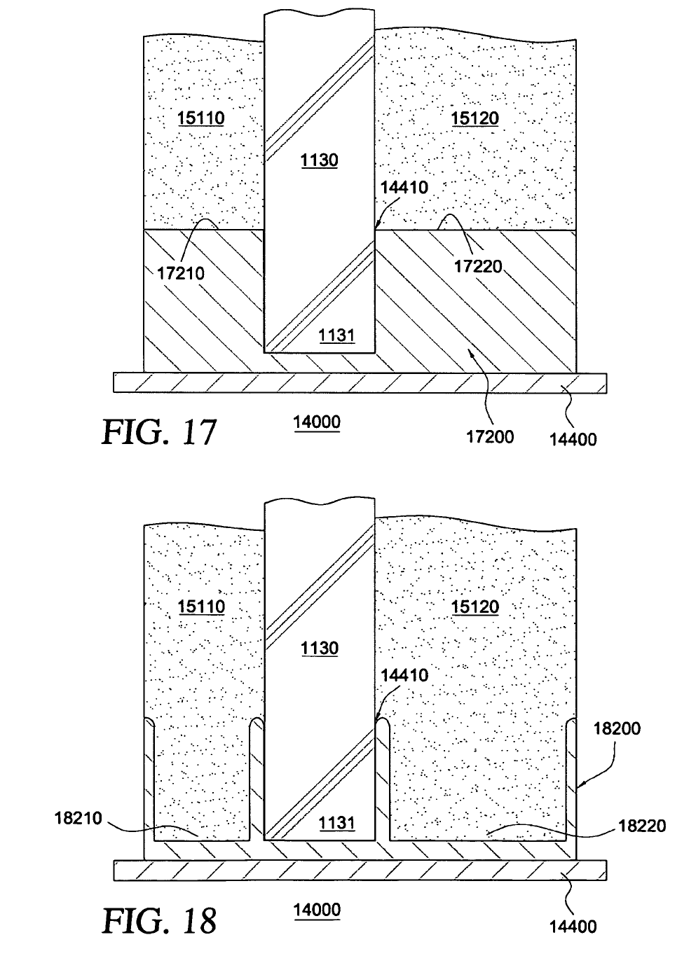

Continuing with the figures, FIG. 17 illustrates a cross-section of plate-mold 17200 that can form part of a panel-form such as panel-forms 14000 and/or 16000. In the present example, plate-mold 17200 forms part of panel-form 14000, and is configured to face the interior of the box formation of panel-form 14000 along wall 14400.

As shown in FIG. 17, plate mold 17200 comprises surface 17210 configured to separate an edge or end of insulation material 15110 from an end of core board 1130 of construction panel 1100, where the end of core board 1130 can comprise protrusion 1131 of core board 1130 (FIGS. 1-2). Similarly, surface 17220 is configured to separate an edge of insulation material 15120 from the end of core board 1130. Surfaces 17210 and 17220 are substantially parallel to each other at opposite sides of core-guide 14410 of wall 14400 of form 14000. In the same or a different example, another plate-mold similar to plate-mold 17200 can be similarly arranged and/or positioned along wall 14300 of panel-form 14000.

FIG. 18 illustrates a cross-section of a plate-mold 18200 that can form part of a panel-form such as panel-forms 14000 and/or 16000. Plate-mold 18200 is similar to plate-mold 17200, but differs by comprising grooves 18210 and 18220 instead of surfaces 17210 and 17220 (FIG. 17).

In the present example, groove 18210 is configured to reduce a thickness of insulation material 15110 at an end of insulation material 15110, while groove 18220 is configured to reduce a thickness of insulation material 15120 at an end of insulation material 15120. Grooves 18210 and 18220 are substantially parallel to each other at opposite sides of core-guide 14410 of wall 14400 of form 14000. In the same or a different example, another plate-mold similar to plate-mold 18200 can be similarly arranged and/or positioned along wall 14300 of panel-form 14000.

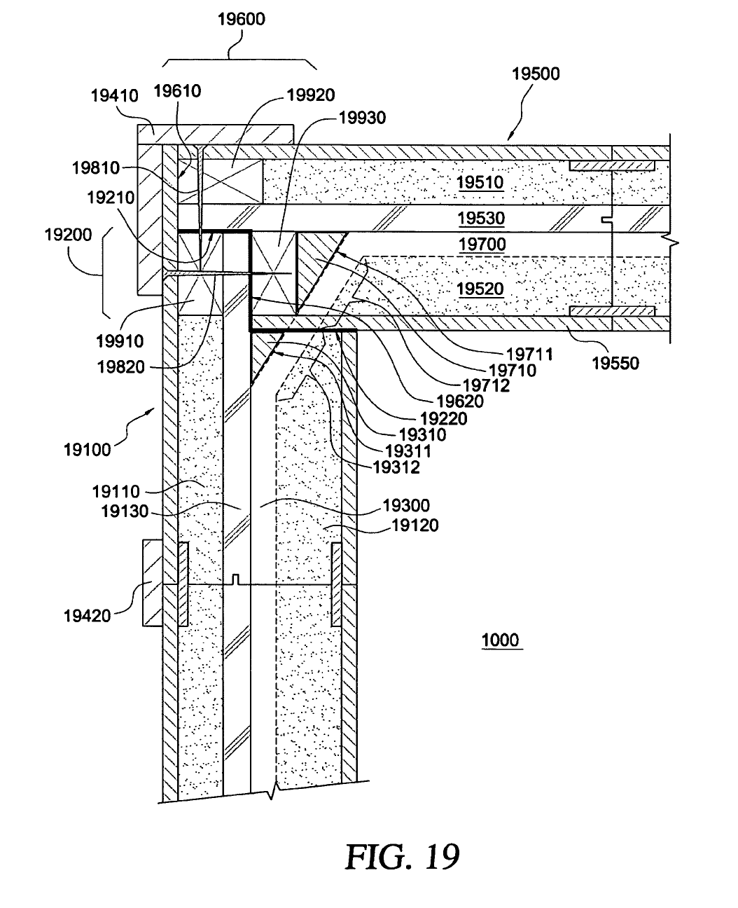

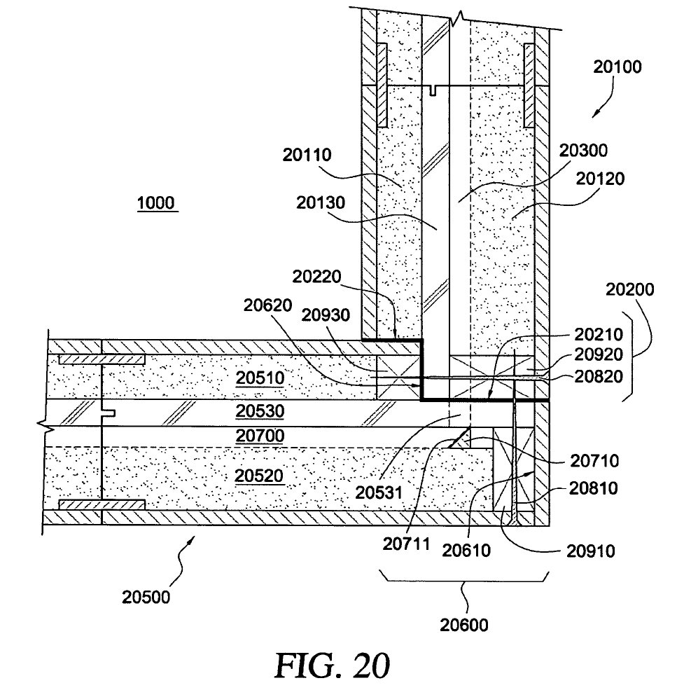

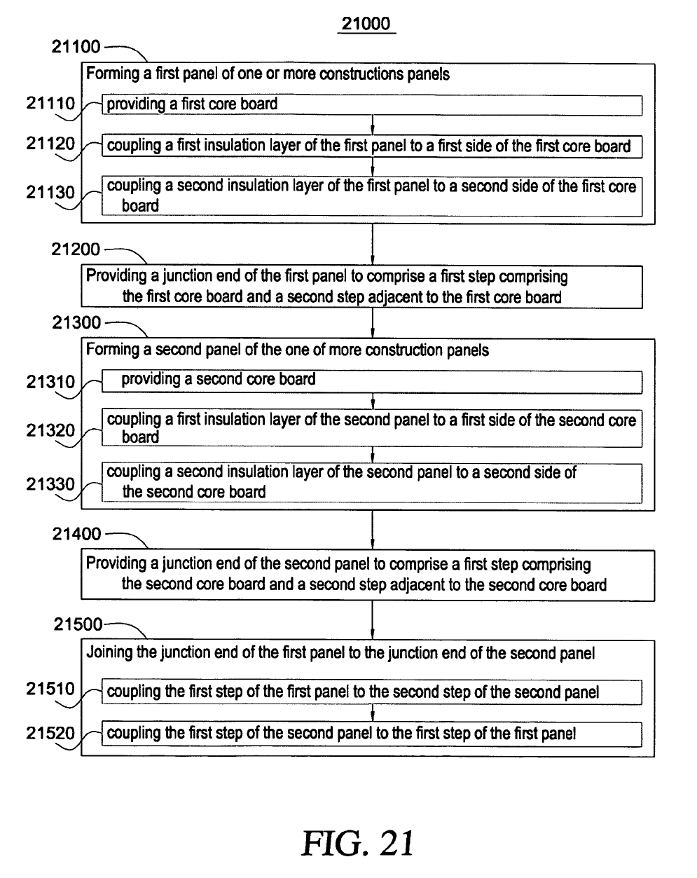

Continuing with the figures, FIG. 19 shows a portion of construction panel system 1000 configured to form an outside corner of a building. FIG. 20 shows a portion of construction panel system 1000 configured to form an inside corner of a building. FIG. 21 shows a flowchart for a method 21000 for manufacturing and/or assembling construction panel system 1000.

A block 21100 of method 21000 comprises forming a first panel of one or more construction panels. As an example, the first panel can be construction panel 19100 (FIG. 19) or construction panel 20100 (FIG. 20) of construction panel system 1000. The first panel can be similar to previously described construction panel 1100 introduced in FIG. 1.

Block 21100 of method 21000 can comprise sub-blocks 21110, 21120, and 21130. Sub-block 21110 of block 21100 comprises providing a first core board for the first panel. In the examples of FIGS. 19-20, the first core board can be any of core boards 19130 and 20130, respectively. The first core board can be similar to core board 1130, as previously described for construction panel 1100 (FIG. 1).

Sub-block 21120 of block 21100 comprises coupling a first insulation layer of the first panel to a first side of the first core board. In the examples of FIGS. 19-20, the first insulation layer of the first panel can be any of insulation layers 19110 and 20110, respectively. The insulation layer of the first panel can be similar to insulation layer 1110 of construction panel 1100 (FIGS. 1-2), and can be coupled to the first side of the first core board, for example, as previously described for insulation layers 1110 (FIGS. 1-2) and/or 15110 (FIGS. 14-18).

Similar to sub-block 21120, sub-block 21130 of block 21100 comprises coupling a second insulation layer of the first panel to a second side of the first core board. In the examples of FIGS. 19-20, the first insulation layer of the first panel can be any of insulation layers 19120 and 20120, respectively. The insulation layer of the first panel can be similar to insulation layer 1120 of construction panel 1100 (FIGS. 1-2), and can be coupled to the second side of the first core board, for example, as previously described for insulation layers 1120 (FIGS. 1-2) and/or 15120 (FIGS. 15-18). Sub-blocks 21120 and 21130 can be performed simultaneously or in reverse order.

A block 21200 of method 21000 comprises providing a junction end of the first panel. The junction end of the first panel comprises a first step comprising the first core board and a second step adjacent to the first core board. The first step comprising the first core board can be collinear with the end of the first insulation layer of the first panel, while the second step adjacent to the first core board can be collinear with the second insulation layer of the first panel. In the examples of FIGS. 19-20, the junction end of the first panel can be junction ends 19200 and 20200 respectively, where the first step comprising the first core board can be any of steps 19210 and 20210, and the second step adjacent to the first core board can be any of steps 19220 and 20220, respectively.

A block 21300 of method 21000 comprises forming a second panel of the one or more construction panels. The second panel can be similar to the first panel, such that block 21300 can be similar to block 21100 of method 21000. As an example, the second panel can be construction panel 19500 (FIG. 19) or construction panel 20500 (FIG. 20) of construction panel system 1000. The second panel can also be similar to previously described construction panel 1100 introduced in FIG. 1.

Block 21300 of method 21000 can comprise sub-blocks 21310, 21320, and 21330. Sub-block 21310 of block 21300 comprises providing a second core board for the second panel. In the examples of FIGS. 19-20, the second core board can be any of core boards 19530 and 20530, respectively. The second core board can also be similar to core board 1130, as previously described for construction panel 1100 (FIG. 1).

Sub-block 21320 of block 21300 comprises coupling a first insulation layer of the second panel first panel to a first side of the second core board. In the examples of FIGS. 19-20, the first insulation layer of the second panel can be any of insulation layers 19510 and 20510, respectively. The first insulation layer of the second panel can also be similar to insulation layer 1110 of construction panel 1100 (FIGS. 1-2), and can be coupled to the first side of the second core board, for example, as previously described for insulation layers 1110 (FIGS. 1-2) and/or 15110 (FIGS. 15-18).

Similar to sub-block 21320, sub-block 21330 of block 21300 comprises coupling a second insulation layer of the second panel first panel to a second side of the second core board. In the examples of FIGS. 19-20, the second insulation layer of the second panel can be any of insulation layers 19520 and 20520, respectively. The second insulation layer of the second panel can be also similar to insulation layer 1120 of construction panel 1100 (FIGS. 1-2), and can be coupled to the second side of the second core board, for example, as previously described for insulation layers 1120 (FIGS. 1-2) and/or 15120 (FIGS. 15-18).

A block 21400 of method 21000 comprises providing a junction end of the second panel. The junction end of the second panel comprises a first step comprising the second core board and a second step adjacent to the second core board. The first step comprising the second core board can be collinear with the first insulation layer of the second panel, while the second step adjacent to the second core board can be collinear with the second insulation layer of the second panel. In the examples of FIGS. 19-20, the junction end of the second panel can be any of junction ends 19600 and 20600, the first step comprising the first core board can be any of step 19610 and 20610, and the second step adjacent to the first core board can be any of steps 19620 and 20620, respectively.

A block 21500 of method 21000 comprises joining the junction end of the first panel to the junction end of the second panel, wherein block 21500 can be carried out via sub-blocks 21510 and 21520. Block 21500 can be accomplished, for example, as illustrated in FIG. 19 for junction ends 19200 and 19600, and/or as illustrated in FIG. 20 for junction ends 20200 and 20600.

Sub-block 21510 of block 21500 comprises coupling the first step of the first panel to the second step of the second panel. As an example, in the embodiment of FIG. 19, step 19210 of construction panel 19100 is coupled to step 19620 of construction panel 19500 through core board 19130. Similarly, as another example in the embodiment of FIG. 20, step 20210 of construction panel 20100 is coupled to step 20620 of construction panel 20500 through core board 20130.

Sub-block 21520 of block 21500 comprises coupling the first step of the second panel to the first step of the first panel. As an example, in the embodiment of FIG. 19, step 19210 of construction panel 19100 is coupled to step 19610 of construction panel 19500 through core board 19530. Similarly, as another example in the embodiment of FIG. 20, step 20610 of construction panel 20500 is coupled to step 20210 of construction panel 20100 through core board 20530. In some examples, sub-blocks 21520 and 21510 can be performed simultaneously or in reverse order.

In one example of method 21000, blocks 21100, 21200, 21300, 21400, and 21500, including their respective subs-steps, can be subparts of a single block. In the same or a different embodiment, the sequence of blocks 21100, 21200, 21300, 21400, and 21500 can be otherwise changed. In addition, blocks 21200, 21300, 21400, and 21500 can be optional depending on the specific example of construction panel system manufactured.

Method 21000 can further optionally comprise providing a first fastener to couple together the junction end of the first panel with the junction end of the second panel. In such an example, the junction end of the first panel can comprise a first coupler post having a length substantially parallel to the junction end of the first panel and located at an end of the first insulation layer of the first panel. In addition, the junction end of the second panel can comprise a second coupler post having a length substantially parallel to the junction end of the second panel and located at an end of first insulation layer of the second panel. The first fastener can be used to couple the first coupler post of the first panel to the second coupler post of the second panel via the second core board of the second panel.

In the same or a different example, method 21000 can further optionally comprise providing a second fastener to couple together the junction end of the first panel with the junction end of the second panel. In such an example, the junction end of the second panel can further comprise a third coupler post having a length substantially parallel to the junction end of the second panel and located at an end of the second insulation layer of the second panel. The second fastener can be used to couple the first coupler post of the first panel to the third coupler post of the second panel via the first core board of the first panel.

FIGS. 19-20 illustrate embodiments of how the first and second fasteners described above can be used to couple the junction end of the first panel with the junction end of the second panel. In FIG. 19, fastener 19810 is shown coupling coupler posts 19920 and 19910 together via core board 19530, while fastener 19820 is shown coupling coupler posts 19910 and 19930 together via core board 19130. Similarly, for FIG. 20, fastener 20810 is shown coupling coupler posts 20920 and 20910 together via core board 20530, while fastener 20820 is shown coupling coupler posts 20920 and 20930 together via core board 20130.

In the same or a different example, method 21000 can further optionally comprise providing a first chase of the first panel, providing a second chase of the second panel, and coupling together the first chase and the second chase when the junction end of the first panel is coupled to the junction end of the second panel. In such an example, the first chase of the first panel can be routed substantially parallel to the first core board of the first panel through at least one of the first insulation layer and the second insulation layer of the first panel. Similarly, the second chase of the second panel can be routed substantially parallel to the second core board of the second panel through at least one of the first insulation layer and the second insulation layer of the second panel.

FIGS. 19-20 illustrate embodiments of how the first chase of the first panel and the second chase of the second panel can be coupled together. In FIG. 19, chase 19300 is routed substantially parallel to core board 19130 through insulation layer 19120 in construction panel 19100, while chase 19700 is routed substantially parallel to core board 19530 through insulation layer 19520 in construction panel 19500, wherein chases 19300 and 19700 couple together at the junction of junction ends 19200 and 19600. Similarly, in FIG. 20, chase 20300 is routed substantially parallel to core board 20130 through insulation layer 20120 in construction panel 20100, while chase 20700 is routed substantially parallel to core board 20530 through insulation layer 20520 in construction panel 20500, wherein chases 20300 and 20700 couple together at the junction of junction ends 20200 and 20600.

In the same or a different example, method 21000 can further optionally comprise providing a chase transition mechanism between the first chase of the first panel and the second chase of the second panel. Such chase transition mechanism can be used to make it easier to route wiring or tubing between the first and second chases, where otherwise the transition between the first and second chases would comprise a sharp angle. The chase transition mechanism progressively transitions the first chase of the first panel and the second chase of the second panel into each other. In one example, the chase transition mechanism can comprise at least one of one or more chase guide blocks, a curved tubing, and/or a progressive cutout of one or more of the first insulation layers of one of or more of the first and second panels.

In one example such as illustrated in FIG. 19 for an outside corner of construction panel system 1000, the chase transition mechanism described above for method 21000 can optionally be implemented via a first chase cutout of the second insulation layer of the first panel located towards the second step of the first panel, in combination with a first chase guide block comprising a first guide face located within the first chase cutout of the second insulation layer of the first panel, wherein a first guide channel is formed between the first guide face of the first chase guide block and the second insulation layer of the first panel. Furthermore, a second chase cutout of the second insulation layer of the second panel located towards the second step of the second panel, in combination with a second chase guide block comprising a second guide face located within the second chase cutout of the second insulation layer of the second panel, can form a second guide channel formed between the second guide face of the second chase guide block and the second insulation layer of the second panel. Such an arrangement can permit the first guide channel of the first panel and the second guide channel of the second panel to couple together when the junction end of the first panel is coupled to the junction end of the second panel.

As illustrated in FIG. 19, an embodiment of the chase transition mechanism described above for outside corners can comprise guide channel 19312 formed between guide face 19311 of chase guide-block 19310 and insulation layer 19120 of construction panel 19100, while guide channel 19712 is formed between guide face 19711 of chase guide-block 19710 and insulation layer 19520 of construction panel 19500. Guide channels 19312 and 19712 couple together when junction ends 19200 and 19600 of construction panels 19100 and 19200 couple together. In examples where one or more of the construction panels comprises a siding panel between the junction ends of the first and second panels, such as the portion of siding panel 19550 of construction panel 19500 between junction ends 19200 and 19600 in the example of FIG. 19, the siding panel can be designed or modified to comprise an opening to permit the first and second guide channels to couple together.

In another example such as illustrated in FIG. 20 for an inside corner of construction panel system 1000, the chase transition mechanism described above for method 21000 can optionally be implemented via a core cutout of the second core board of the second panel, where the core cutout is collinear with the first chase of the first panel when the junction end of the first panel couples to the junction end of the second panel. In the same example, a chase guide block comprising a guide face can be located within the second chase of the second panel to be accessible through the first chase of the first panel via the core cutout when the junction end of the first panel couples to the junction end of the second panel.

As illustrated in FIG. 20, an embodiment of the chase transition mechanism described above for inside corners can comprise core cutout 20531 through core board 20530, where core cutout 20531 is collinear with chase 20300 of construction panel 20100 when junction end 20200 of construction panel 20100 couples with junction end 20600 of construction panel 20500. As shown in the present embodiment, core cutout 20531 is substantially perpendicular to chase 20700 of construction panel 20500. In addition, guide face 20711 of chase guide block 20710 is located within chase 20700 proximate to core cutout 20531 and accessible to chase 20300 of construction panel 20100. When junction ends 20200 and 20600 of construction panels 20100 and 20500 are coupled together, guide face 20711 of chase guide block 20710 can be used to facilitate the routing of wiring, cabling, and/or tubing being “fished” along a transition path from chase 20300 to chase 20700, or vice-versa, by decreasing the magnitude of an angle of the inside corner. In one embodiment, core cutout 20531 of core board 20530 can also comprise a diagonal expansion opposite guide face 20711 to further open and facilitate the transition path between chases 20700 and 20300, where the diagonal expansion can be substantially parallel to guide face 20711 in some examples.

Although the invention has been described with reference to specific embodiments, it will be understood by those skilled in the art that various changes may be made without departing from the spirit or scope of the invention. For example, to one of ordinary skill in the art, it will be readily apparent that a construction panel could comprise a junction end such as junction end 19200 of construction panel 19100 (FIG. 19) opposite a linkage end such as groove end 1170 of construction panel 1100 (FIG. 4). In the same or another example, one of the construction panels of construction panel system 1000 could comprise an interior panel having a single insulation layer with no core board and with siding panels at opposite sides of the insulation layer, where the interior panel may be non-load-bearing. In the same or a different example, different portions of construction panel system 1000 can be covered with trim panels, such as trim panels 6910 and 6920 (FIG. 6), trim panel 12100 (FIG. 12), and/or trim panels 19410 and 19420 (FIG. 19). Also, wall 14400 in FIGS. 14 and 17 can be modified to form an anchor bolt slot such as slot 1160 in FIG. 1. Additional examples have been given in the foregoing description. Accordingly, the disclosure of embodiments of the invention is intended to be illustrative of the scope of the invention and is not intended to be limiting. It is intended that the scope of the invention shall be limited only to the extent required by the appended claims. To one of ordinary skill in the art, it will be readily apparent that the construction panel system and method of manufacture thereof discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

All elements claimed in any particular claim are essential to the invention claimed in that particular claim Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A construction panel system comprising:
a first panel of one or more construction panels comprising:
a core board;
a first insulation layer coupled to a first side of the core board; and
a second insulation layer coupled to a second side of the core board;
wherein:
the first insulation layer substantially covers the first side of the core board; and
the second insulation layer substantially covers the second side of the core board.

2. The construction panel system of claim 1, wherein:
the core board of the first panel comprises at least one of:
an oriented strand board material; and
a plywood material;
and
at least one of the first and second insulation layers of the first panel comprise at least one of:
a polystyrene material;
a polyurethane material; and
a soy-based insulation material.

3. The construction panel system of claim 1, wherein:
the core board of the first panel comprises a thickness of approximately 1.9 centimeters;
at least one of the first and second insulation layers of the first panel comprises a thickness of between approximately 2.54 and 10.16 centimeters;
at least one of the first and second insulation layers of the first panel comprises a density of between approximately 16 and 160 kilograms per cubic meter; and
the first and second insulation layers have different thicknesses.

4. The construction panel system of claim 1, wherein:
the first panel comprises one or more chases traversed substantially parallel to the core board through at least one of the first insulation layer and the second insulation layer.

5. The construction panel system of claim 1, further comprising:
a first siding panel coupled to the first insulation layer opposite the core board.

6. The construction panel system of claim 5, further comprising:
a second siding panel coupled to the second insulation layer opposite the core board.

7. The construction panel system of claim 5, wherein:
the first siding panel comprises at least one of:
a Magnesiacore® board;
a gypsum board;
a high density composite material; and
a fiber cement layer.

8. The construction panel system of claim 1; wherein:
the core board comprises a first protrusion along a first end of the core board; and
the first protrusion extends a first protrusion distance beyond the first and second insulation layers.

9. The construction panel system of claim 8; further comprising:
a first plate comprising:
a groove along a length of the first plate;
a first surface along the length of the first plate; and
a second surface along the length of the first plate;
wherein:
the first and second surfaces are adjacent to opposite sides of the groove;
a width of the groove is complementary to a width of the first protrusion of the core board of the first panel;
a width of the first surface is complementary to a width of the first insulation layer of the first panel;
a width of the second surface is complementary to a width of the second insulation layer of the first panel; and
the first protrusion distance of the core board is less than or equal to a depth of the groove.

10. The construction panel system of claim 9, wherein:
the first plate comprises at least one of:
a pressure-treated wood material;
an engineered wood material;
an extruded metal material;
a roll-formed metal material.

11. The construction panel system of claim 9, further comprising:
a second plate comprising a second groove along a length of the second plate;
wherein:
the core board comprises a second protrusion along a second end of the core board opposite the first end of the core board;
the second protrusion extends a second protrusion distance beyond the first and second insulation layers;
a width of the second groove of the second plate is complementary to a width of the second protrusion of the core board; and
the second protrusion distance of the core board is less than or equal to a depth of the second groove.

12. The construction panel system of claim 11, further comprising:
a first siding panel configured to couple to the first insulation layer and opposite the core board of the first panel;
wherein:
the first siding panel comprises:
a first siding protrusion extended past the first insulation layer; and
a second siding protrusion extended past the first insulation layer and opposite the first siding protrusion;
the first siding protrusion of the first siding panel is configured to couple to and at least partially cover a first side of the first plate; and
the second siding protrusion of the first siding panel is configured to couple to and at least partially cover a first side of the second plate.

13. The construction panel system of claim 9, further comprising:
one or more anchor bolts comprising one or more bolt heads;
wherein the one or more anchor bolts are configured to traverse at least one of the first and second surfaces of the first plate and secure the first plate to a base surface.

14. The construction panel system of claim 13, wherein:
the one or more bolt heads protrude above the first surface of the first plate;
the first panel comprises an anchor bolt slot along a bottom side of at least one of the first insulation layer and the second insulation layer; and
the anchor bolt slot is configured to accommodate the one or more bolt heads when the first protrusion of the first panel is coupled to the groove of the first plate.

15. The construction panel system of claim 9, further comprising:
a roof structure coupled to the first plate;
wherein;
the first protrusion of the core board of the first panel is coupled to the groove of the first plate; and
the core board of the first panel is configured to support at least a load of the roof structure transmitted via the first plate.

16. The construction panel system of claim 15, further comprising:
a compression block located between the first plate and at least one of the first and second insulation layers of the first panel.

17. The construction panel system of claim 1, further comprising:
a second panel of the one or more construction panels;
wherein:
the first panel further comprises a groove along a first panel groove end;
the second panel further comprises a tab along a second panel tab end;
the groove of the first panel groove end is complementary to the tab of the second panel tab end; and
the groove of the first panel groove end and the tab of the second panel tab end are configured to couple together when the first panel is coupled with the second panel along the first panel groove end and the second panel tab end.

18. The construction panel system of claim 1, further comprising:
a first linkage structure of one or more linkage structures comprising at least one of:
a spline; and
a structural post configured to bear loads; and
a second panel of the one of more construction panels comprising:
a second core board;
a first insulation layer coupled to a first side of the second core board; and
a second insulation layer coupled to a second side of the second core board;
wherein:
at least one of the first and second insulation layers of the first panel comprises a first one of one or more first-panel linkage slots along a first-panel linkage end;
at least one of the first and second insulation layers of the second panel comprises a first one of one or more second-panel linkage slots along a second-panel linkage end;
a first end of the first linkage structure is configured to couple with the first one of the one or more first-panel linkage slots along the first-panel linkage end when the first panel and the second panel are coupled together; and
a second end of the first linkage structure is configured to couple with the first one of the one or more second-panel linkage slots along the second-panel linkage end when the first panel and the second panel are coupled together.

19. The construction panel system of claim 1, further comprising:
a wall opening periphery cut through the first panel of the one or more construction panels; and
one or more bucks positioned along the wall opening periphery.

20. The construction panel system of claim 19, further comprising:
a second panel of the one or more construction panels;
wherein the wall opening periphery is configured to span the first and second panels.

21. The construction panel system of claim 1, further comprising:
a wall opening structure comprising:
the first panel of the one or more construction panels,
second, third and fourth panels of the one or more construction panels; and
first, second, third, and fourth bucks;
wherein:
a first end of the first panel is configured to couple along a first side of the first buck;
a first end of the second panel is configured to couple along a first side of the second buck;
a first end of the third panel is configured to couple to a second side of the first buck at a top portion of the first buck;
a first end of the fourth panel is configured to couple to the second side of the first buck at a bottom portion of the first buck;
a second end of the third panel is configured to couple to a second side of the second buck at a top portion of the second buck;
a second end of the fourth panel is configured to couple to the second side of the second buck at a bottom portion of the second buck;
a third end of the third panel is configured to couple to a first side of the third buck;
a third end of the fourth panel is configured to couple to a first side of the fourth buck;
the first buck is configured to accommodate the core board of the first panel, the core board of the third panel, and the core board of the fourth panel;
the second buck is configured to accommodate the core board of the second panel, the core board of the third panel, and the core board of the fourth panel;
the third buck is configured to accommodate the core board of the third panel; and
the fourth buck is configured to accommodate the core board of the fourth panel.

22. The construction panel system of claim 1, further comprising:
a roof structure comprising at least the first panel of the one or more construction panels.

23. The construction panel system of claim 1, further comprising:
a plumbing panel comprising:
a core board;
a first insulation layer coupled to a first side of the core board;
two posts coupled along opposite ends of a second side of the core board; and
a first siding panel having opposite ends coupled along the two posts.

24. A panel-form configured to assemble a construction panel, the construction panel comprising a core board, a first insulation material, and a second insulation material, the panel-form comprising:
a first wall comprising a first core-guide;
a second wall facing the first wall and comprising a second core-guide substantially parallel to the first core-guide
a third wall comprising a third core-guide;
a fourth wall facing the third wall and comprising a fourth core-guide substantially parallel to the third core-guide;
a fifth wall;
a sixth wall facing the fifth wall;
wherein:
the first, second, third, fourth, fifth, and sixth walls are configured to be coupled together in a box formation;
the first, second, third, and fourth core-guides are configured to face an interior of the box formation.

25. The panel-form of claim 24, further comprising:
a first insulation division inside the panel-form; and
a second insulation division inside the panel-form;
wherein:
the first core-guide is complementary to a first end of the core board of the construction panel;
the second core-guide is complementary to a second end of the core board of the construction panel;
the third first core-guide is complementary to a third end of the core board of the construction panel;
the fourth core-guide is complementary to a fourth end of the core board of the construction panel;
the core board of the construction panel is configured to divide the interior of the box formation between the first and second insulation divisions when coupled to the first, second, third, and fourth core guides;
the first insulation division comprises a first insertion point from an exterior of the box formation;
the second insulation division comprises a second insertion point from the exterior of the box formation;
the first insulation division is configured to shape the first insulation material inserted through the first insertion point;
the second insulation division is configured to shape the second insulation material inserted through the second insertion point; and
the first and second insulation materials of the construction panel are configured to couple to opposite sides of the core board.

26. The panel-form of claim 24, wherein:
one of the first, second, third, fourth, fifth, and sixth walls comprises a first siding panel configured to couple to the first insulation material, and
another one of the first, second, third, fourth, fifth, and sixth walls of the panel-form comprises a second siding panel configured to couple to the second insulation material.

27. The panel-form of claim 24, further comprising:
a first one of one or more linkage structure molds along a first side of the panel-form and adjacent to at least one of the first, fifth, and sixth walls; and
a second one of the one or more linkage structure molds along a second side of the panel-form and adjacent to at least one of the second, fifth, and sixth walls.

28. The panel-form of claim 24, further comprising:
a first one of one or more plate-molds configured to face the interior of the box formation of the panel-form along at least one of the third and fourth walls of the panel-form;
wherein:
the first one of the one or more plate-molds comprises:
a first surface configured to separate an edge of the first insulation material of the construction panel from an end of the core board of the construction panel; and
a second surface configured to separate an edge of the second insulation material of the construction panel from the end of the core board of the construction panel;
and
the first and second surfaces are substantially parallel to each other at opposite sides of at least one of the third and fourth core guides of the panel-form.

29. The panel-form of claim 24, further comprising:
a first one of one or more plate-molds configured to face the interior of the box formation of the panel-form along at least one of the third and fourth walls of the panel-form;
wherein:
the first one of the one or more plate-molds comprises:
a first groove configured to reduce a width of the first insulation material of the construction panel at an end of the first insulation material; and
a second groove configured to reduce a width of the second insulation material of the construction panel at an end of the second insulation material;
and
the first and second grooves are substantially parallel to each other at opposite sides of at least one of the third and fourth core guides of the panel-form.

30. A method for manufacturing a construction panel system, the method comprising:
forming a first panel of one or more constructions panels comprising:
providing a first core board;
coupling a first insulation layer of the first panel to a first side of the first core board;
and
coupling a second insulation layer of the first panel to a second side of the first core board.

31. The method of claim 30, wherein forming the first panel further comprises:
providing a junction end of the first panel to comprise:
a first step comprising the first core board; and
a second step adjacent to the first core board.

32. The method of claim 31, further comprising:
forming a second panel of the one of more construction panels comprising:
providing a second core board;
coupling a first insulation layer of the second panel to a first side of the second core board; and
coupling a second insulation layer of the second panel to a second side of the second core board;
providing a junction end of the second panel to comprise:
a first step of the second panel comprising the second core board; and
a second step of the second panel adjacent to the second core board.
wherein:
the first step of the first panel is designed to be coupled to the second step of the second panel; and
the first step of the second panel is designed to be coupled to the first step of the first panel.

33. A construction panel comprising:
an insulation layer;
a first adhesion coupling
a second adhesion coupling;
a first siding panel coupled to a first side of the insulation layer via the first adhesion coupling; and
a second siding panel coupled to a second side of the insulation layer via the second adhesion coupling;
wherein the first siding panel comprises a first mesh of one or more meshes.

34. The construction panel of claim 33, wherein:
the first and second adhesion couplings are configured to enhance a load-hearing capability of the construction panel via a combination of structural integrities of at least two of the insulation layer, the first siding panel, and the second siding panel.

35. The construction panel of claim 33, wherein:
the insulation layer comprises at least one of a thickness and a density configured to enhance the load-bearing capability of the construction panel.

36. The construction panel of claim 35, wherein:
the density of the insulation layer is between approximately 16 and 160 kilograms per cubic meter.

37. The construction panel of claim 33, wherein:
at least one of the first and second siding panels comprises at least one of:
a magnesium oxide board; and
a composite material board.

38. The construction panel of claim 33, wherein:
at least one of the first and second adhesion couplings comprises at least one of:
glue; and
bonds formed during a curing process of the insulation layer.

39. The construction panel of claim 33, wherein:
the one or more meshes comprise at least one of:
a fiberglass mesh;
a Kevlar® mesh;
a carbon-fiber mesh; and
a composite-material mesh.
